(19) United States
(12) Patent Application Publication
(10) Pub. No.: US 2010/0017742 A1
(43) Pub. Date: Jan. 21, 2010

(54) FORM INPUT SKIP-FIELD SOFTWARE TOOL

(76) Inventors: Gary J. Rhodes, Springfield, IL (US); Glenn H. Farrell, Peoria, IL (US)

Correspondence Address: Russ Weinzimmer, 614 Nashua Street, Suite 53, Milford, NH, 03055, US

(21) Appl. No.: 12/176,397

(22) Filed: Jul. 20, 2008

(51) Int. Cl. G06F 3/048

(52) U.S. Cl. 715/780

(57) ABSTRACT

A software tool and method are disclosed for enabling efficient input of data into a form by enabling a user to cause certain fields to be skipped except when needed. The input form includes a plurality of input fields, at least one of which has a corresponding check box or other skip field control. The skip field control enables a user to specify whether or not the corresponding input field will be skipped when the input focus is sequentially advanced, for example by using the tab or enter key. In preferred embodiments, a mouse or other pointing device can be used to select a skipped field when it is needed for input. Some embodiments allow only authorized users to change skip field settings. Skip field controls can apply to groups of input fields, and a hide-skip-field control can be included to hide and reveal the skip field controls.

### FIELD OF THE INVENTION

The invention generally relates to computer user interfaces and more particularly to computer user interfaces for inputting data records.

### BACKGROUND OF THE INVENTION

Inputting data into a computer often requires repetitive typing of entries into rigid data input forms (or just “forms”), which are specialized user interface controls for inputting data. A data input form has input fields that accept user data, which may be input using a keyboard, mouse or other input device. For example, a typical data input form might have input fields labeled “Name” “Address”, and “Zip” into which the user is expected to type the corresponding information.

Before typing an item of data into an input field, a user must first select the field that will receive the item of data. This can usually be done by using the mouse to click on the desired field. However, it is often more efficient when filling out an entire form to use a designated key such as the tab key to advance the input focus sequentially from one field to the next as the data is entered.

The design of a particular data input form frequently represents the format of data records to be stored in a database. Often, a user must input many different data records into the same data input form. For example:

(a) an attorney may wish to input a rolodex of contacts into a contact manager database, information on each contact being a data record;

(b) an accountant may need to input the receipts from a given month of transactions into a financial management program, information on each receipt being a data record; or

(c) a salesperson may need to insert many new customers each day into a sales tracking database, the information on each customer being a data record.

In situations like these, standard data input forms can be inefficient when there are mismatches between the design of the data input form and the characteristics of the majority of the data to be input. A data input form that is designed for widely varying kinds of data must often include input fields that are superfluous for most of the data being input. For example, a data input form may have a field for a name designation such as “Jr.” or “III,” when in fact very few people have such a designation as part of their name. The input field might be necessary for the sake of names that do require it, and yet be rarely used.

In such a case, a user will be constantly required to tab over the rarely used input fields. Not only does this waste time and keystrokes, it risks the user's forgetting to tab over the rarely used fields, thereby risking that data will be input into the wrong input fields.

Some existing software tools provide the option of disabling an input field entirely. Input fields disabled in this way are usually displayed in gray or sometimes not displayed at all. These systems are difficult to reconfigure, however, when it becomes necessary to input data that requires the disabled input field, since re-enabling the disabled input field can require knowledge of rarely-used procedures and menu options. The end result is often that a user becomes frustrated and decides to endure the inefficiency of having all fields enabled.

Other software tools provide an option to set the value of a “skip field” property for a rarely used input field. When the “skip field” value is “skip”, the field can be selected using the mouse, but cannot be reached using the tab character. When the value is “do-not-skip”, the rarely used input field can be selected either by the mouse or by the tab character. Such software options, however, are typically difficult to use, since they require reformatting of graphic configuration files, modification of user profiles, or mastery of programming languages. At the very least, these software options require that the user open an entirely new configuration window and then master the correspondence between controls in the configuration window and controls in the data input form.

### SUMMARY OF THE INVENTION

A software tool and method are disclosed for efficiently entering data into a data input form by tagging rarely used input fields such that they are skipped unless specifically selected for input. Typically, “skip field” checkboxes or similar controls are displayed simultaneously with the input form, such that a skip field control is proximal to and associated with each of at least some of the input fields in the data input form. Checking of a skip field checkbox causes the corresponding input field to be skipped when the input focus is sequentially advanced using the tab character. However, the input field is not disabled, and may be selected for input when needed using a mouse or other pointing device.

One general aspect of the invention is a computer-implemented method for efficiently inputting data into a data input form. The method includes displaying a data input form on a display device to a user, the data input form including a plurality of input fields. For at least one input field, the method further includes providing a skip field control visually cooperative with the input field, the skip field control being operable by a user so as to input a Boolean value of a skip field property of the input field. The method then includes accepting user specification of the Boolean value of the skip field property, the Boolean value being either ‘skip’ or ‘do-not-skip.’ Upon input by the user of an input-focus-advance command, the method further includes moving an input focus to a next input field that does not have a skip field property whose Boolean value is ‘skip.’ Finally, the method includes receiving data into the input field that has the input focus, the data being input by the user using an input device.

In preferred embodiments, the input-focus-advance command is input by the user by depressing a tab character on a keyboard. In further preferred embodiments, each of the input fields is selectable by a pointing device regardless of skip field property values. In some preferred embodiments, for each input field that has a skip field property, the value of the skip field property is visually displayable.

In various preferred embodiments, the method further includes displaying a show/hide control that enables a user to display and hide a skip field control. In some of these embodiments, the skip field control is operable by a user so as to input a single Boolean value applicable to the skip field property of each input field within a group of input fields.

In preferred embodiments, the skip field control is configurable so as to deny to a user permission to change the corresponding skip field property when the user's access control level is insufficient. In some embodiments, the method further includes transmitting over a network at least one of the user specified Boolean value and the data received into the input field. And in some of these embodiments the network is the internet.

Another general aspect of the invention is an article of manufacture for efficiently inputting data into a data form on a computer, the article of manufacture comprising a computer-readable medium containing software that is able to direct the actions of a computer so as to cause the computer to execute the steps of:

displaying a data input form on a display device to a user, the data input form including a plurality of input fields;

for at least one input field, providing a skip field control visually cooperative with the input field, the skip field control being operable by a user so as to input a Boolean value of a skip field property of the input field;

accepting user specification of the Boolean value of the skip field property, the Boolean value being one of ‘skip’ and ‘do-not-skip’;

upon input by the user of an input-focus-advance command, moving the input focus to a next input field that does not have a skip field property whose Boolean value is ‘skip’; and

receiving data into the input field that has the input focus, the data being input by the user using an input device.

In preferred embodiments, the input-focus-advance command is input by the user by depressing a tab character on a keyboard. In other preferred embodiments each of the data fields is selectable by a pointing device regardless of skip field property values. In still other preferred embodiments, for each input field that has a skip-field property, the value of the skip field property is visually displayable.

In preferred embodiments, the steps executed by the computer further include displaying a show/hide control that enables a user to display and hide a skip field control. In other preferred embodiments the skip field control is operable by a user so as to input a single Boolean value applicable to the skip field property of each input field within a group of input fields. In still further preferred embodiments the skip field control is configurable so as to deny to a user permission to change the corresponding skip field property when the user's access control level is insufficient.

In preferred embodiments, the steps executed by the computer further include transmitting over a network at least one of the user specified Boolean value and the data received into the input field. And in some of these embodiments the network is the internet.

A third general aspect of the invention is a device for efficiently obtaining information from a data input form. The device includes a server computer configured to transmit information defining a data input form to a client computer and to receive from the client computer corresponding information obtained by the client computer using the data input form. The corresponding information is transmitted by the client computer to the server computer over a network, the client computer having executed steps that include the following:

displaying the data input form on a display device to a user, the data input form including a plurality of input fields;

for at least one input field, providing a skip field control visually cooperative with the input field, the skip field control being operable by a user so as to input a Boolean value of a skip field property of the input field;

accepting user specification of the Boolean value of the skip field property, the Boolean value being one of skip and do-not-skip;

upon input by the user of an input-focus-advance command, moving an input focus to a next input field that does not have a skip field property whose Boolean value is skip;

receiving data into the input field that has the input focus, the data being input by the user using an input device; and

transmitting the data received into the data input form to the server computer.

In preferred embodiments of this general aspect, the network is the internet.

### BRIEF DESCRIPTION OF THE DRAWINGS

FIG. 1A is a view of an exemplary data input form of the present invention with the skip field controls hidden;

FIG. 1B is a view of the exemplary data input form of FIG. 1A with the skip field controls revealed;

FIG. 1C is a view of the exemplary data input form of FIG. 1B with additional skip field properties selected;

FIG. 1D is a view of the exemplary data input form of FIG. 1C with the skip field controls hidden and additional data entered;

FIG. 2A depicts a flow chart showing the flow of control in a preferred embodiment in which the present invention is implemented on a single computer;

FIG. 2B depicts a flow chart showing the flow of control in a preferred embodiment in which the present invention is implemented on a server and a client computer; and

FIG. 2C, presents an expanded illustration of the skip field step of FIG. 2A and FIG. 2B.

### DETAILED DESCRIPTION OF PREFERRED EMBODIMENTS

The present invention is applicable to computer data input forms that utilize a “next field” command to advance an input focus through a chain of input fields, so as to sequentially enter data into the input fields using a keyboard. The invention enhances the ease, accuracy, and efficiency with which such data can be entered by providing skip field controls that allow input fields that are rarely used to be easily and conveniently flagged by a user, such that they are skipped by the next field command during the normal course of keyboard data entry, but nevertheless remain available for selection by a pointing device when needed. The skip field controls are displayed simultaneously with, and proximal to, the input fields to which they correspond.

A data input form generally includes a plurality of input fields, each of which can accept input entered by means of an input device such as a keyboard or mouse. In many cases, depending on the design of the input form and the information that it is intended to receive, most or all of the input fields are text fields that accept alphanumeric input from a keyboard. Some data input forms include other types of input field, such as radio buttons and/or drop-down menus that accept specific kinds of data, such as dates, menu options, colors, and so on. A button control can also be used as a type of input field, for example a button that can be repeatedly clicked so as to select a value from a list by toggling through the list.

The computer or other electronic device that generates, controls, and received data from the data input forms of the present invention can be a local device, or it can be a server computer or other electronic device that is in communication by wired or wireless means with the electronic display on which the forms are presented, for example over the internet over the telephone network, or over some other network.

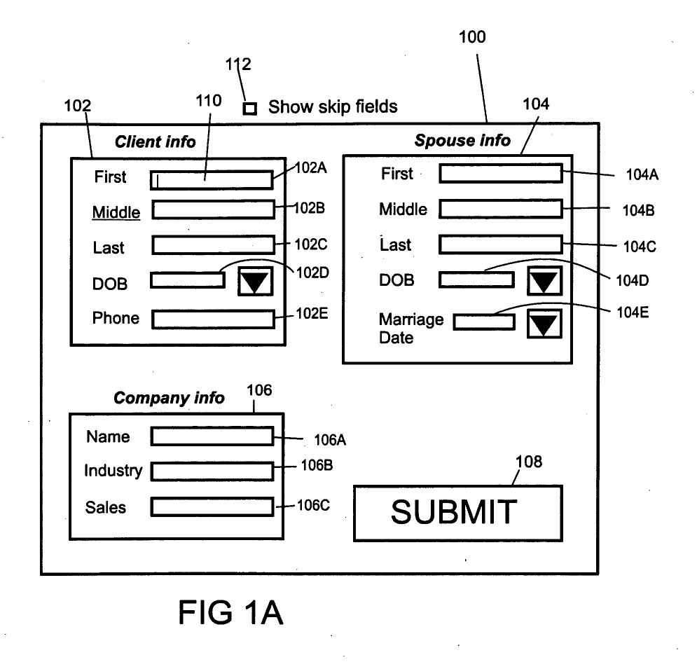

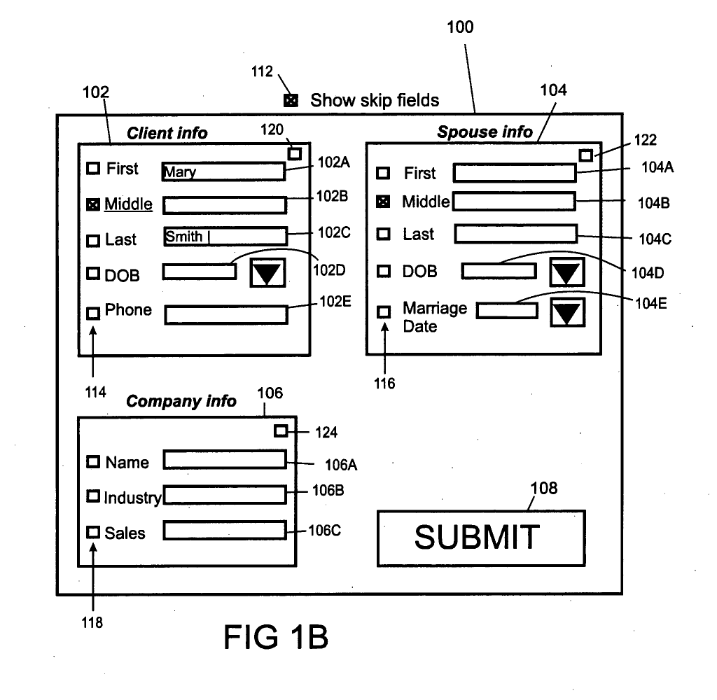

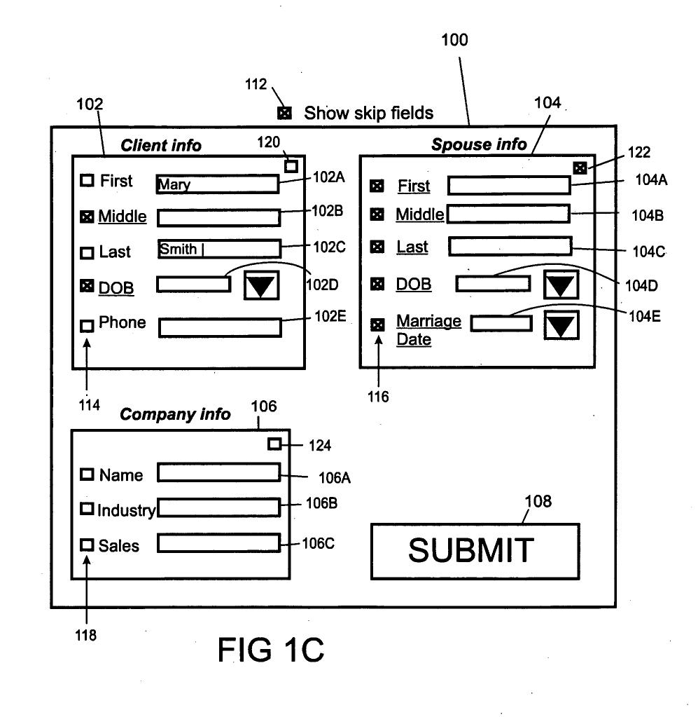

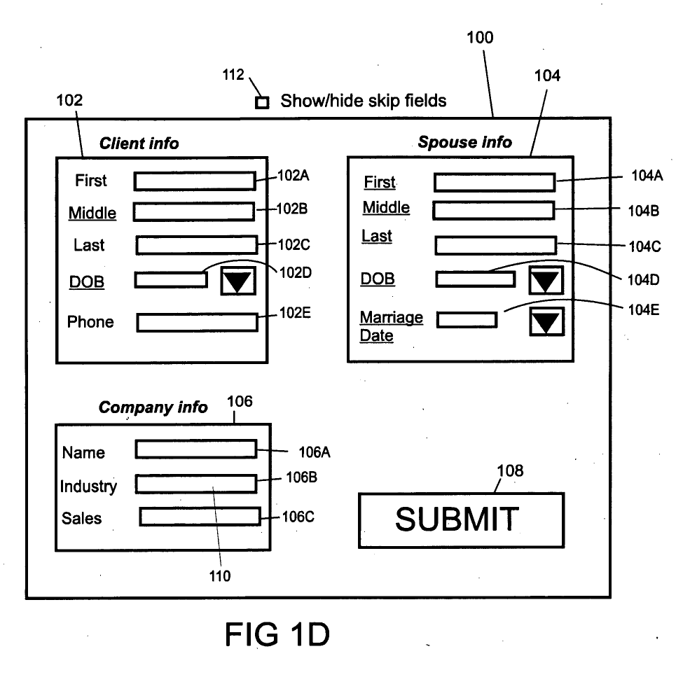

FIG. 1A presents an example of a data input form 100 to which the present invention is applicable. The data input form 100 is divided into input sections 102, 104, 106, each of which contains a plurality of input fields, 102A through 102E, 104A through 104E, and 106A through 106C. The first input section 102 includes input fields 102A through 102E that accept data relating to a client. The second input section 104 includes input fields 104A through 104E that accept data relating to the spouse of the client, and the third input section 106 includes input fields 106A through 106C that accept data relating to a company with which the client is associated.

Most of the input fields in FIG. 1A are text boxes that accept alphanumeric text from a keyboard. However, three of the input fields, 102D, 104D, and 104E, are “drop-down” boxes that can accept only dates selected from a list. A “Submit” button 108 is also included so as to enable submitting of the information from a completed form and beginning of a new one.

While some types of data input field, such as the drop-down boxes 102D, 104D, 104E included in FIG. 1A, are able to accept input from a pointing device, such as a mouse, it is nevertheless often more efficient when entering large amounts of data to provide input to these input fields from a keyboard, for example by striking the space bar to activate a button, or by typing the first letter of a selection from a drop-down list 102D, 104D, 104E. This is because entering as much data as possible using the keyboard minimizes the need for a user to move a hand back and forth between the keyboard and a pointing device.

When data is supplied to a data input form 100 using a keyboard, it is necessary to specify the input field to which the data will be directed. One very common approach is to assign a so-called “input focus” to an input form, and to move the input focus from one input field to another as input is supplied to the form. In FIG. 1A, the input focus is illustrated as being on the input field 102A for the client's first name. This can be seen by the presence of a text cursor 110 in that input field. Typically, most or all of the input fields are logically linked together to form an input focus chain, such that each input field is associated with a next input field, and entry of a “next field” command causes the input focus to advance sequentially through the chain. In preferred embodiments, the next field command is entered by striking the “tab” key on the keyboard. In the example of FIG. 1A, the input fields might be linked such that the input focus moves sequentially through the input fields for the client 102, the client's spouse 104, and the client's company 106 according to the item numbering given in the figure.

In all embodiments of the present invention, at least one input field has associated with it a so-called “skip field” control that can be used to conveniently set and clear a skip field property of the input field. In FIG. 1A, the skip field controls are hidden. However, the input field 202B labeled “Middle” is underlined, thereby providing a visual indication that it has a skip field property set to skip, and will be skipped over when the tab key is pressed. The skipped field controls can be made visible in the embodiment of FIG. 1A by checking a “show skip fields” checkbox 112. The result is illustrated in FIG. 1B. A “skip field” check box 114, 116, 118 is displayed next to each of the input fields, and in addition a separate skip field box 120, 122, 124 is associated with each of the input regions 102, 104, 106. The skip field property for each input field accepts a Boolean value that is referred to herein as being either “skip” or “do-not-skip.” An input field with a skip field property value of “skip” is referred to herein as being a “skipped” input field. In the embodiment of FIG. 1B, the value of the skip field property is “skip” if the corresponding skip field checkbox 114, 116, 118, 120, 122, 124 is checked. If an input section skip field checkbox 120, 122, 124 is checked, all input fields within the input section are set to be skipped.

In the example of FIG. 1B, check boxes are used as skip field controls. In other embodiments, toggle buttons or other controls well known in the art are used as skip field controls. In some embodiments, the data input field itself serves as a skip field control. For example, in some embodiments, double clicking or right-clicking on a data input field with a mouse or other pointing device changes the skip field value of the data input field, and in other embodiments right clicking or double clicking on a data input field activates a pop-up menu that allows the value of the skip field property for the data input field to be set.

As can be seen from FIG. 1A and FIG. 1B, the data input form 100 remains operable precisely as if the skip field capability were not present, but with the added power of controlling the skip field properties if desired. This added capability enables a user to enhance the speed and efficiency with which data can be input without complicating the user experience or requiring the use of any additional windows or additional forms. Moreover, preferred embodiments such as FIG. 1A and FIG. 1B do not even require significant additional screen space. The skip field checkboxes 114, 116, 118, 120, 122, 124 are small and can be hidden if desired, and the function of each skip field checkbox is immediately apparent because of its proximity to the field or group of fields that it controls.

When the “next field” command is entered, for example by striking the tab or enter key, skipped input fields are literally skipped in the input focus chain, such that the input focus moves to the next input field that is not a “skipped” input field. In FIG. 1B, for example, the middle name of the client 102B and his or her spouse 104B are skipped. The figure shows the result of having entered a first name for a client 102A, having pressed the tab key (whereby the middle name field 102B has been skipped), and having entered a last name 102C for the client. The input focus remains in the client last name field 102C, and will advance to the date of birth field 102D upon the next typing of the tab key.

In the example of FIG. 1B. If it becomes necessary to input a series of clients for whom spouse information is not known or is not relevant, then the entire spouse input section can be skipped simply by checking the spouse section skip field checkbox 122. In preferred embodiments, if all other input fields are skipped fields, the next field command causes the input focus to remain unchanged.

Because the skip field controls are displayed simultaneously with the data input form and proximally to their corresponding input fields, as illustrated in FIG. 1B, this allows the skip field values to be readily and easily viewed and changed by a user, so as to maximize the efficiency of each data entry session.

FIG. 1C shows the data input form 100 of FIG. 1B after the user has checked an additional two skip field checkboxes, namely the skip field control checkbox corresponding to the input field 102D labeled “DOB” and the input section skip field checkbox 122 corresponding to the input section 104 labeled “Spouse info.”

By checking the skip field checkbox 122 for the spouse input field group 104, each of the five field-specific skip field controls 116 corresponding to input fields 104A-104E in the input field group 104 has been checked, and the entire group of input fields 104A-104E in the input field group will be skipped when the user traverses the fields using the tab key.

In FIG. 1D, the show skip fields checkbox 112 has been cleared, causing the skip field controls to be hidden. The user has input two consecutive tabs after entering the client's last name 102C, thereby moving the input focus 110 over the DOB input field 102D and the input field 102E labeled “Phone” to reach the input field 106A labeled “Name” in the Company Info input region 106. The user has then typed the name of the company “ABC Co.,” input another tab character to move the input focus 110 to the input field 106B labeled “Industry,” and input “Accounting.” If there is no sales information to be entered into the “sales” input field 106C, the user can press the submit button 108 to transmit and store the data that has been entered into the data input form 100, thereby indicating that there is a new client “Mary Smith” working for “ABC Co.” in the “Accounting” industry.

In different preferred embodiments, the appearance of the input form will vary depending on the application, the windowing system, the operating system, and sometimes the host browser if the form is displayed over the internet. Shadowing or a 3D-effect can be used in the text fields. A variety of buttons can be used to facilitate entry of some kinds of data, such as radio buttons, drop down buttons, and the like. Various fonts and colors can be used to distinguish different kinds of input fields, or to improve legibility. Labels for skip fields can be displayed in a different font or color than labels of other fields rather than (or in addition to) being underlined, or the skipped fields themselves can be displayed in other colors or have other visual indications. Menu bars consistent with the windowing system can appear above the form. When the form is too long to fit on a screen, a scroll bar can be provided so that a user can view the entire form. A pull-down menu or other control can be used instead of a checkbox to show or hide fields, and/or to control skip field properties.

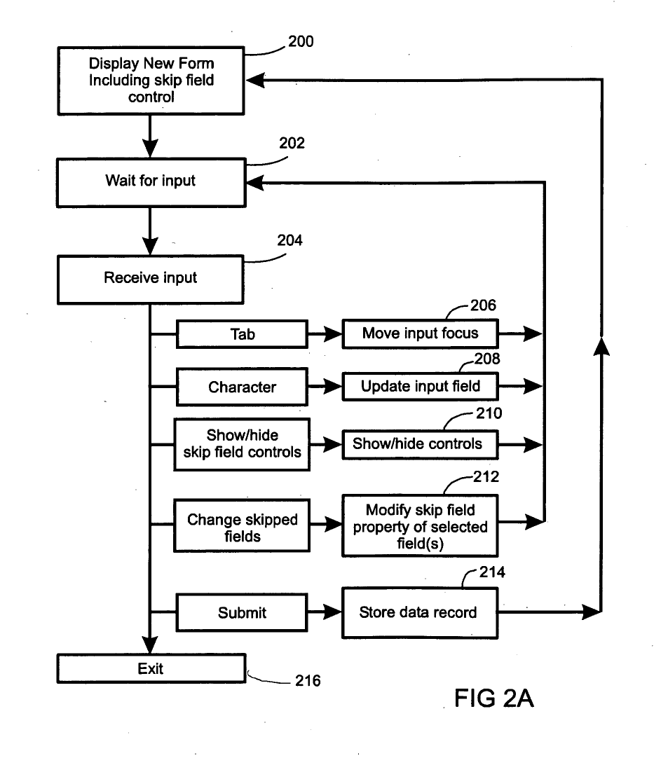

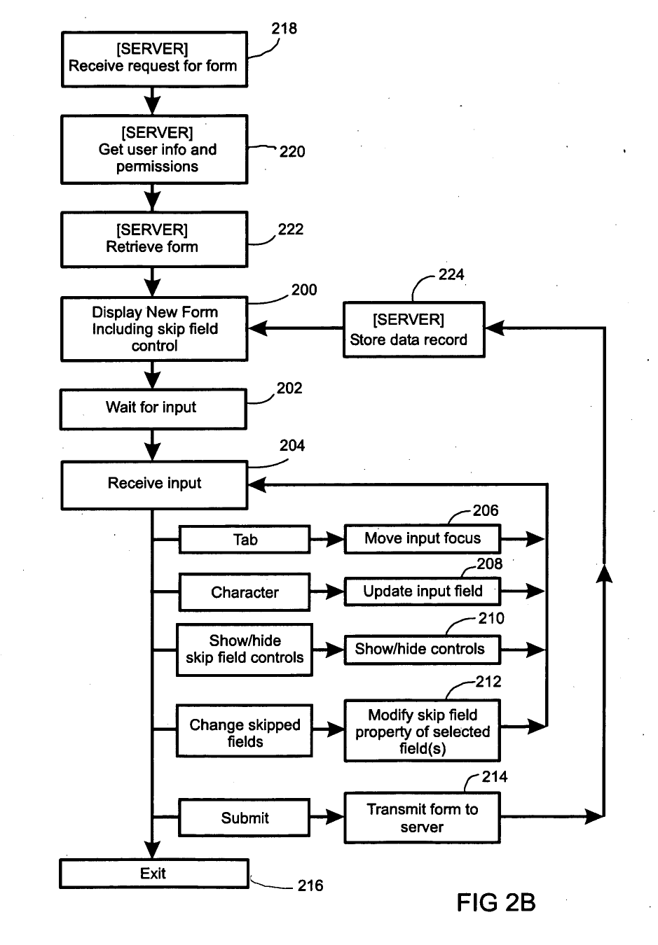

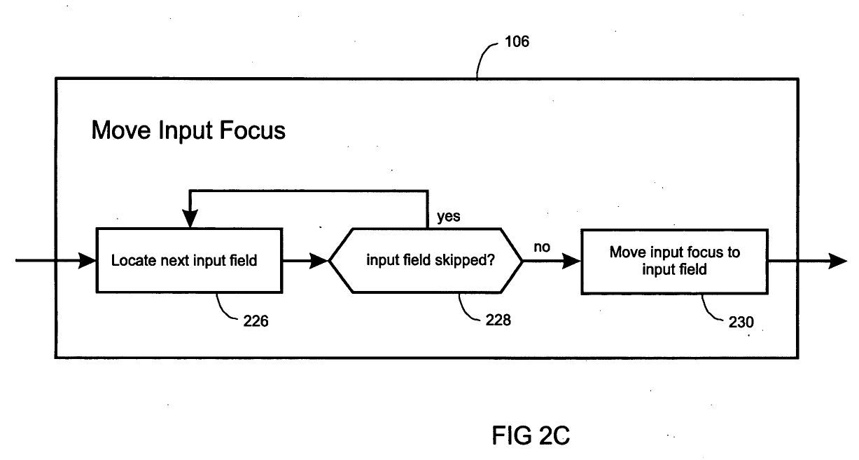

FIG. 2A depicts the steps that are followed in a preferred embodiment in which the method of the invention is implemented on a single computer. The computer initially displays an empty form 200, including at least one skip field control associated with at least one input field, and then waits for input 202. The input focus is initially located on a default first input field.

When input is received 204, it is analyzed to determine the nature of the input. If it is a next field command, such as a tab key 206, then the input focus is moved to the next input field in the input focus chain that is not skipped. If it is input appropriate for the input field that has the input focus, such as an alphanumeric character 208, then it is entered into the input field.

Certain preferred embodiments include “show/hide skip field” controls that cause some or all of the skip field controls to be displayed or hidden. If one of these controls is activated 210, then the skip field controls are revealed or hidden according to the status of the show/hide control.

If a command to change the status of a skipped field property is received 212, for example by checking or clearing a skipped field control check box, then the corresponding property is changed. In preferred embodiments such as the embodiment of FIG. 1B, the current values of some or all of the skipped field properties are presented on the display.

Once all desired information has been entered into the form, a submit command is entered 214, thereby causing the information to be stored in a data record of a database and a blank form to be once again displayed 200. In similar embodiments, some or all of the data is not entered into a database, but is instead used for some other purpose. For example, credit card information may not be stored, but may be transmitted across a secure network to a banking server so as to complete a purchase transaction.

Finally, if there is no more data to be entered, the data entry session is terminated 216.

FIG. 2B depicts the steps that are followed in a preferred embodiment similar to the embodiment of FIG. 2A, but in which a client computer and a server computer communicate with each other over a network. In step 218, a server computer receives a request to display a data input form, the request including the particular data input form requested as well as user identifying information, such as a user ID, a handle, a name, or a cookie. In this embodiment, the request to display a data input form is initiated by the client (“pull architecture”) but in similar embodiments the request can also be initiated by the server (“push architecture”), perhaps in response to another client request.

In step 220, the server uses the user identity information to retrieve the access control information for the user. The access control information may be stored in any kind of database, and in some preferred embodiments the access control information can be included with the user identity information. The retrieval of the access control information may itself require additional communication with the client or with other computers, as might be used, for example, when the information is encrypted and transmitted over SSL. If all users for this kind of data input form have full privileges, then a preferred embodiment can skip the step of retrieving the access control information, because the access control information is already known.

In step 222, the server retrieves configuration information regarding the data input form, such as its shape, arrangement of fields, overall layout and color, and the format of data accepted within each field. This configuration information can be stored in many ways: as a Java Bean, as an XML file, as a binary image, as a Windows graphical user element, and so forth. The configuration also includes information about skipped field controls, where they will be placed and which input fields they will be associated with.

In step 222, the server also sends the configuration information characterizing the new data input form to the client. This sending of data can include sending a pointer or reference to the client which, when followed, contains the configuration information. The client computer then displays the input form 200, including at least one skip field control, and in some embodiments also a show/hide skip fields control. In preferred embodiments, the show/hide skip fields control is a checkbox displayed on top of the data input form. In other preferred embodiments the show/hide skip fields control is accessed through a pull-down menu from a menu bar.

The client computer then waits for input 202. The remainder of the steps are essentially equivalent to the steps in FIG. 1A. In step 204, the client receives some user input. Note that some types of user input are handled transparently by the operating system, such as mouse moves, and are not included in the figure.

Step 206 illustrates the effect of the user pressing the tab key (assuming the focus is within the input form). The input focus is moved to the next input field that is not skipped. If there is no such next input field, then the input focus is unchanged In some preferred embodiments the client can be configured to use a next field command other than the tab key. This is useful if some of the input fields require tabs in their contents.

A mouse or other pointing device can also be used in some embodiments to change the input focus. A mouse click on an input field typically moves the input focus to that field. In preferred embodiments in most windowing programming languages such as Java AWT, Microsoft .NET, Visual BASIC, etc. these types of input are handled automatically by the operating system.

Step 208 illustrates the effect of the user inputting a standard text character from the keyboard. If the input field that currently has the input focus accepts alphanumeric input, then the character is simply appended to the contents of the input field. In some preferred embodiments an input field can be configured to have a length restriction, such that if appending a character to the contents of that input field would exceed the length restriction for that field, the character is not appended.

Certain keyboard input is also accepted in step 208 so as to enter data into input fields that include a radio button, drop-down box, or other non-alphanumeric input control. For example, the keyboard space bar can be used to check or uncheck a checkbox or activate a button, and typing the first letter of an entry in a list can cause selection of that entry from a drop-down box.

Step 210 is executed when a user clicks on a show/hide skip field control. In some preferred embodiments, the show/hide skip field control is a toggle button, such that if the skip field controls are hidden they are displayed, and if they are displayed then they are hidden. In other preferred embodiments, the show/hide skip field control is a checkbox, such that the skip field controls are displayed if the checkbox is checked, and not displayed if the checkbox is not checked.

In preferred embodiments, the skip field controls are checkboxes, with a skip field checkbox being located near each individual input field, as well as skip field checkboxes being associated with groups of input fields. When a skip field checkbox adjacent to an input field is checked 212, then, subject to the user's access control permission, the input field next to that checkbox becomes a skipped field. In preferred embodiments, skip field values are persistent, and are retained the next time the user accesses the data input form. When the checkbox adjacent to an input field is unchecked, the input field reverts to no longer being skipped. In further preferred embodiments, when a checkbox associated with a group of input fields is checked, all of the input fields in that group become checked, subject to access control permissions of the user. And when a checkbox associated with a group of input fields is unchecked, all the input fields in that group become unchecked, subject to access control permissions. The data input form remains completely usable whether or not the skip field controls are displayed.

When the user clicks the SUBMIT button, step 214 is executed, and the contents of the data input form's input fields are transmitted to the server, in preferred embodiments using a network communication protocol such as http, or a higher-level protocol such as CORBA, Java RMI or .NET.

In step 224, the server uses the information from the data input form to construct a new data record and to save that data record to a database. Sometimes multiple input fields from the form correspond to a single field in the database schema to which the data record conforms, and sometimes one input field corresponds to multiple fields in the database schema to which the data record conforms. Once the record is saved, the server instructs the client to display a new form 200, thereby clearing the input fields of the current data input form. The new form retains the skip field properties of the previous data input form. This process continues until the user exits in step 216.

FIG. 2C presents in expanded illustration of the Move Input Focus step 206 of FIG. 2A and FIG. 2B. The step begins by locating the next sequential input field 226 in the input focus chain. The input field is then queried 228 to see if it has a skip field property, and if so whether the value is set to skip or do-not-skip. If the property exists and its value is set to skip, then the next input field in the chain is located 226 and the process repeats. When an input field is located that is not skipped, the input focus is moved 230 to that input field.

Other modifications and implementations will occur to those skilled in the art without departing from the spirit and the scope of the invention as claimed. Accordingly, the above description is not intended to limit the invention except as indicated in the following claims.

What is claimed is:

1. A computer-implemented method for efficiently inputting data into a data input form, the method comprising:
displaying a data input form on a display device to a user, the data input form including a plurality of input fields;
for at least one input field, providing a skip field control visually cooperative with the input field, the skip field control being operable by a user so as to input a Boolean value of a skip field property of the input field;
accepting user specification of the Boolean value of the skip field property, the Boolean value being one of ‘skip’ and ‘do-not-skip’;
upon input by the user of an input-focus-advance command, moving an input focus to a next input field that does not have a skip field property whose Boolean value is ‘skip’; and
receiving data into the input field that has the input focus, the data being input by the user using an input device.

2. The method of claim 1, wherein the input-focus-advance command is input by the user by depressing a tab character on a keyboard.

3. The method of claim 1, wherein each of the input fields is selectable by a pointing device regardless of skip field property values.

4. The method of claim 1, wherein for each input field that has a skip-field property, the value of the skip field property is visually displayable.

5. The method of claim 1, further comprising displaying a show/hide control that enables a user to display and hide a skip field control.

6. The method of claim 1, wherein the skip field control is operable by a user so as to input a single Boolean value applicable to the skip field property of each input field within a group of input fields.

7. The method of claim 1, wherein the skip field control is configurable so as to deny to a user permission to change the corresponding skip field property when the user's access control level is insufficient.

8. The method of claim 1, further comprising transmitting over a network at least one of the user specified Boolean value and the data received into the input field.

9. The method of claim 8, wherein the network is the internet.

10. An article of manufacture for efficiently inputting data into a data form on a computer, the article of manufacture comprising:
a computer-readable medium containing software that is able to direct the actions of a computer so as to cause the computer to perform a method that includes the following:
displaying a data input form on a display device to a user, the data input form including a plurality of input fields;
for at least one input field, providing a skip field control visually cooperative with the input field, the skip field control being operable by a user so as to input a Boolean value of a skip field property of the input field;
accepting user specification of the Boolean value of the skip field property, the Boolean value being one of ‘skip’ and ‘do-not-skip’;
upon input by the user of an input-focus-advance command, moving an input focus to a next input field that does not have a skip field property whose Boolean value is ‘skip’; and
receiving data into the input field that has the input focus, the data being input by the user using an input device.

11. The article of manufacture of claim 10, wherein the input-focus-advance command is input by the user by depressing a tab character on a keyboard.

12. The article of manufacture of claim 10, wherein each of the input fields is selectable by a pointing device regardless of skip field property values.

13. The article of manufacture of claim 10, wherein for each input field that has a skip-field property, the value of the skip field property is visually displayable.

14. The article of manufacture of claim 10, further comprising displaying a show/hide control that enables a user to display and hide a skip field control.

15. The article of manufacture of claim 10, wherein the skip field control is operable by a user so as to input a single Boolean value applicable to the skip field property of each input field within a group of input fields.

16. The article of manufacture of claim 10, wherein the skip field control is configurable so as to deny to a user permission to change the corresponding skip field property when the user's access control level is insufficient.

17. The article of manufacture of claim 10, further comprising transmitting over a network at least one of the user specified Boolean value and the data received into the input field.

18. The article of manufacture of claim 17, wherein the network is the internet.

19. A device for efficiently obtaining information from a data input form, the device comprising a server computer configured to transmit information defining a data input form to a client computer and to receive from the client computer corresponding information obtained by the client computer using the data input form, the corresponding information being transmitted by the client computer to the server computer over a network, the client computer having executed steps including:
displaying a data input form on a display device to a user, the data input form including a plurality of input fields;
for at least one input field, providing a skip field control visually cooperative with the input field, the skip field control being operable by a user so as to input a Boolean value of a skip field property of the input field;
accepting user specification of the Boolean value of the skip field property, the Boolean value being one of ‘skip’ and ‘do-not-skip’;
upon input by the user of an input-focus-advance command, moving an input focus to a next input field that does not have a skip field property whose Boolean value is ‘skip’; and
receiving data into the input field that has the input focus, the data being input by the user using an input device; and
transmitting the data received into the data input form to the server computer.

20. The server computer of claim 19, wherein the network is the internet.
